(19) United States
(12) Patent Application Publication
(10) Pub. No.: US 2009/0086911 A1
(43) Pub. Date: Apr. 2, 2009

(54) INSPECTION TOOL FOR RADIOGRAPHIC SYSTEMS

(75) Inventors: Manoharan Venugopal, Bangalore (IN); Nityanand Gopalika, Cincinnati, OH (US); Manoj Kumar Meethal, Annur(PO) (IN); Debasish Mishra, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/862,363

(22) Filed: Sep. 27, 2007

(51) Int. Cl. H05G 1/46

(52) U.S. Cl. 378/96

(57) ABSTRACT

A system for radiographic inspection of an object is provided. The system comprises a radiation source configured to generate radiation, a display unit for generating a graphical user interface (GUI) including multiple fields. A user provides input data via the fields in the GUI. A processor configured to compute a plurality of exposure parameters based on the input data and a control system is configured to initialize the radiation source with the exposure parameters.

### BACKGROUND

The invention relates generally to industrial radiography and more specifically to an inspection-planning system for radiographic inspection

Conventionally, in radiographic inspection systems, a beam of high-energy radiation such as X-rays or Gamma rays is transmitted through a test object to be inspected and a corresponding image of the test object is formed on the imaging devices. A flaw, defect or structural inhomogeneity in the test object is detected by examining the image generated.

For reliable inspection, the image should have desired image quality. The image quality is governed by various parameters such as contrast, signal to noise ratio and spatial resolution. To obtain the desired image quality, suitable radiographic exposure parameters need to be selected. In existing radiographic inspection systems, the desired exposure parameters are obtained after performing several trial experiments.

In most situations, determining the right x-ray technique for an inspection process using trial experiments is time consuming. In addition, many inspection systems have various types of radiation sources that are adapted for inspecting specific types of objects. Using a trial method to calculate the exposure parameters for each type of source and for a specific object could be a cumbersome task. Also, in specific inspection systems, it is required to inspect various objects in a short period of time. Since the exposure parameters may be different for the different objects, the increased time for accurately determining the exposure parameters leads to loss in productivity.

Therefore, it is desirable to implement a method that is capable of automatically determining exposure parameters for various radiation sources based on the object being inspected.

### BRIEF DESCRIPTION

Briefly, in accordance with one embodiment, a system for radiographic inspection of an object is provided. The system comprises a radiation source configured to generate x-rays, and a display unit configured to display a graphical user interface comprising a plurality of fields. A user provides input data in at least one of the fields. The system further includes a processor configured to compute a plurality of exposure parameters for the radiation source based on the input data.

In another embodiment, a method for radiographic inspection of an object is provided. The method comprises irradiating an object with radiation, generating a graphical user interface comprising a plurality of fields, providing input data in at least one of the plurality of fields and computing a plurality of exposure parameters based on the input data. The input data comprises at least one of a thickness of the object, a type of radiation source, a material of the object, a distance between a radiation source and a radiation detector and a magnification factor.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary embodiment of an inspection system implemented according to one aspect of the invention;

FIG. 2 is a flow chart illustrating a method by which an object is inspected according to an aspect of the invention;

FIG. 3 is a diagrammatic view of a graphical user interface implemented according to one aspect of the invention; and

FIG. 4 is a flow chart illustrating an optimization algorithm implemented according to one aspect of the invention.

### DETAILED DESCRIPTION

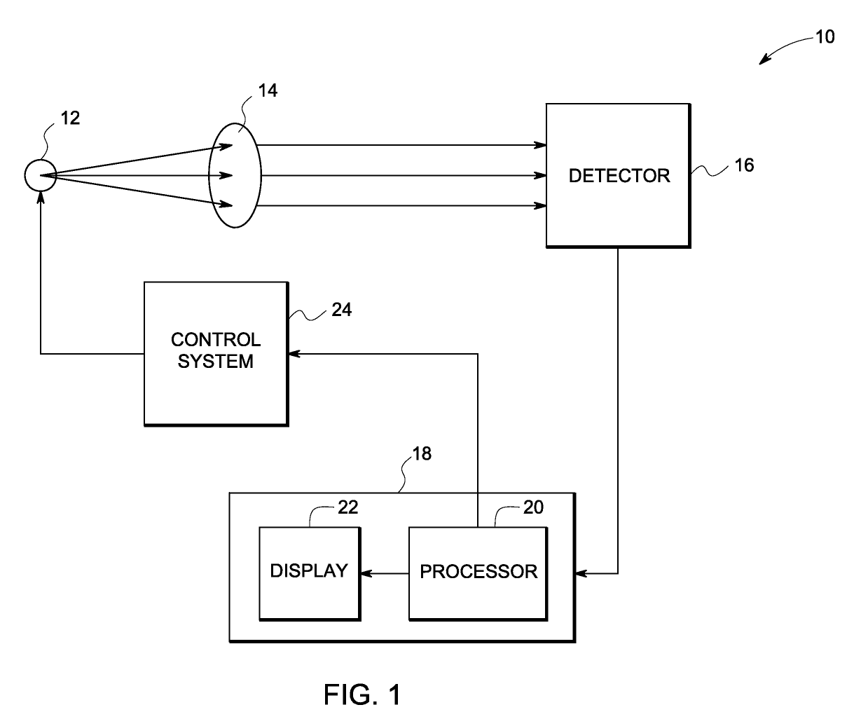

FIG. 1 is a block diagram of one embodiment of a radiographic inspection system implemented in accordance with one aspect of the invention. Radiographic inspection system 10 comprises a radiation source 12, object 14, a detector 16, a processor 18 and a control system 24. Each component is described in further detail below.

As used herein, “adapted to”, “configured” and the like refer to mechanical or structural connections between elements to allow the elements to cooperate to provide a described effect; these terms also refer to operation capabilities of electrical elements such as analog or digital computers or application specific devices (such as an application specific integrated circuit (ASIC)) that are programmed to perform a sequel to provide an output in response to given input signals.

Radiation source 12 is configured to generate x-ray spectrum for given voltage, current, target and filters to irradiate an object 14. In one embodiment, the radiation source is an X-ray source or radioactive isotopes. Example objects include, without limitation, metallic objects.

Detector 16 is configured to receive the radiation energy passing through the object. The detector is configured to convert the received radiation into corresponding electrical signals.

Computer system 18 comprises a processor 20 and a display unit 22. The processor is configured to implement an inspection tool that is adapted to receive the electrical signals from the detector and generate a corresponding image of the object. The display unit is used to display an image of the object.

The display unit is further adapted to display a graphical user interface comprising a plurality of fields. The fields are adapted to accept input data provided by a user. Input data comprises information related to the object being inspected and/or the radiation source and detector, material and thickness of filters, source to detector distance and image quality requirements. For example, the user can provide information on a thickness of the object, a type of radiation source being used, a material of the object, a distance between the radiation source and a radiation detector, a magnification factor, etc. The input data is used to calculate the exposure parameters for the radiation source, which will result in generating an image with a desired gray level.

Control system 24 receives the computed exposure parameters from the computer system and is configured to automatically set the exposure parameters of the radiation source based on the input data provided by the user. The manner in which the processor computes the exposure parameters of the radiation source is described in further detail below.

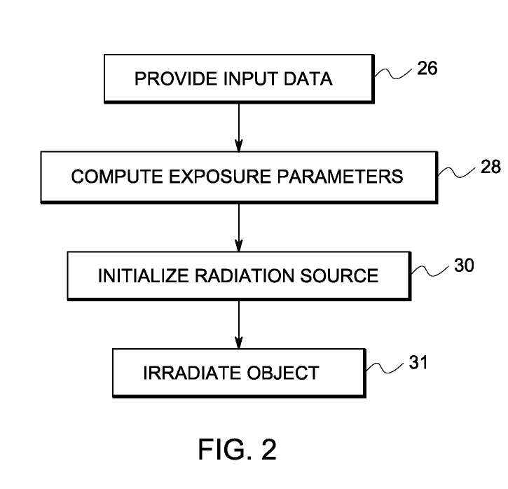

FIG. 2 is a flow chart illustrating a method by which an object is inspected using a radiographic inspection planning tool implemented according to an aspect of the invention. The tool implements an algorithm that includes several steps for computing a required gray level of an image for a given set of system constraints. Each step is described in further detail below.

In step 26, a user provides input data via a graphical user interface. The input data comprises information related to the object being inspected and/or the radiation source and detector.

In step 28, exposure parameters are computed using the input data provided by the user. Exposure parameters include a current input parameter and a voltage input parameter. Another example exposure parameter is exposure time. The exposure parameters are computed such that the resulting image generated by the processor is of a desired gray level. In order to arrive at accurate exposure parameters, the interaction of the radiation energy with the object being inspected is modeled.

In step 30, the radiation source is initialized with the computed exposure parameters using a control system. In step 31, the object is irradiated with radiation generated by the radiation source. The computed exposure parameters are also displayed on the graphical user interface. An exemplary graphical user interface is described in further detail below.

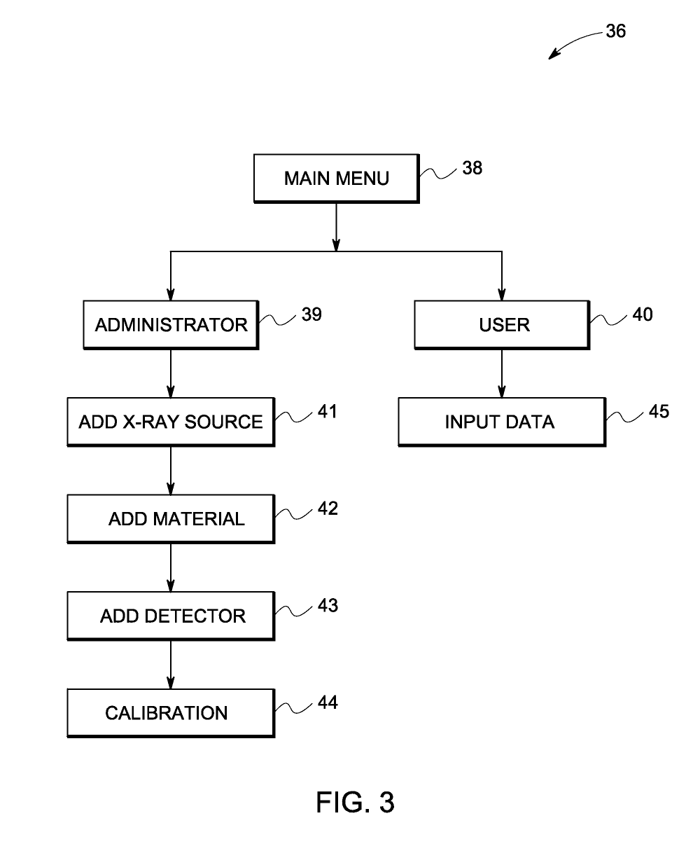

FIG. 3 is a diagrammatic view of an exemplary graphical user interface (GUI) adapted for accepting input data provided by a user. As used herein, input data refers to data related to the object being inspected, the radiation source and/or the radiation detector being used by the inspection system. The input data is in turn used as system constraints while computing the exposure parameters.

GUI 36 comprises a plurality of fields 38-45. The main menu 38 is designed to provide access to an administrator in field 39 or a user in field 40. The administrator may provide data pertaining to various radiation sources, various detectors, metallic and non-metallic material data and calibration data. For example, field 41 is configured to accept data related to the different types of radiation sources that are used in industrial applications.

Similarly, field 42 is configured to accept input data related to the material of the object. In a more specific embodiment, a standard list of materials comprising elements and alloys can be stored in the system.

Additionally, the GUI also enables a user to provide data related to the various types of detectors used in industrial applications in field 43. Field 44 is configured to accept calibration data.

The user provides input data in field 45. Examples of input data include material of the object being inspected, the source and/or detector being used by the inspection system, the source to object distance, the source to detector distance. On entering the input data, the exposure parameters are displayed in fields 46. The exposure parameters include a current input parameter (i.e., current×time of exposure) and a voltage input parameter.

The exposure parameters are calculated as described in step 28 of FIG. 2. In a further embodiment, an optimization algorithm is additionally employed to determine optimum exposure parameters. The optimization algorithm is described in further detail below.

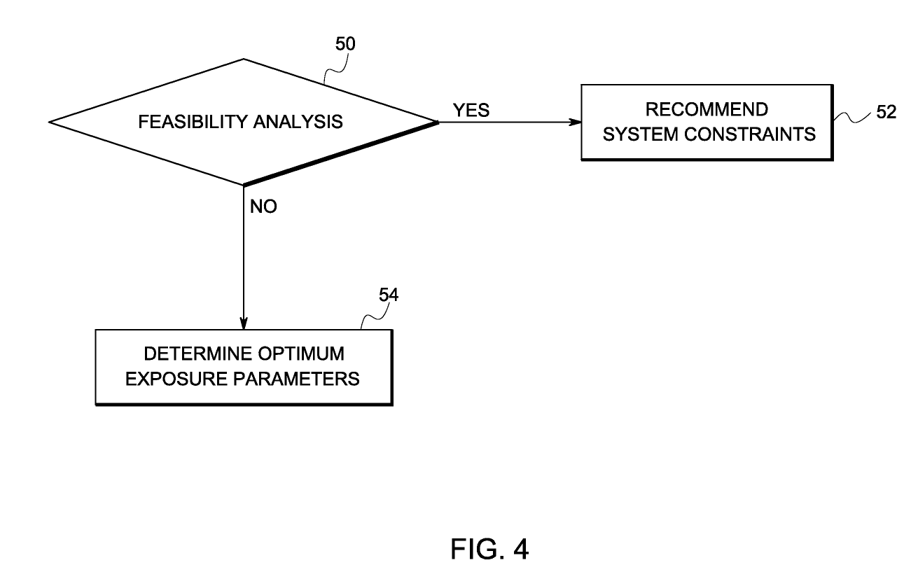

FIG. 4 is a flow chart illustrating an optimization algorithm used to determine the optimum exposure parameters to obtain the required gray level in an image. The optimization algorithm is configured to accept operating input data from a user and generate optimum exposure parameters through simulating a contrast to noise ratio. The manner in which the optimization algorithm is employed is described below in detail.

In step 50, a feasibility analysis is performed to determine if the desired gray level for the image can be achieved with input data provided by the user. If the desired gray level cannot be achieved, an optimum magnification or a suitable focal spot size is recommended as shown is step 52. Else, as shown in step 54, optimum exposure parameters are calculated keeping the system components and their operating range as constraints.

In one embodiment, the optimum exposure parameters are calculated by using a contrast to noise ratio (CNR) per unit incident radiation dose on the detector. In a specific embodiment, a CNR of 3 is used. The optimization algorithm determines an optimum operating point that result in the highest CNR with a minimum dose of radiation to the detector. The radiation source voltage, current and exposure time corresponding to the optimum operating point are then used as exposure parameters for the radiation source.

The optimization algorithm uses numerical modeling of the entire imaging chain. The imaging chain is divided into three categories comprising the radiation spectrum generation, radiation interaction with the object and a detector response. According to one aspect of the invention, all three categories are numerically modeled.

The radiation interaction with the object considers an effect of scatter radiation. In one embodiment, the scatter correction is defined using a scatter to direct ratio (SDR). SDR considers a fraction of a scatter radiation that reaches a maximum region of interest in the detector plane. In one embodiment, the maximum region of interest comprises the image of the object on the detector. In one embodiment, the detector response is modeled using a transfer function that relates an absorbed energy in the detector to a gray scale response of the detector.

The above described invention provides several advantages including accurate measurements of exposure parameters and a substantial reduction in inspection time. In addition, the described technique is generic and can be used for various types of radiation sources and/or detectors. Since the technique can be used for a wide band of energy, the tool can be applied for clinical applications as well.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for radiographic inspection planning of an object, the system comprising:
a radiation source configured to generate x-ray;
a display unit for displaying a graphical user interface comprising a plurality of fields, wherein a user provides an input data in at least one of the plurality of fields; and
a processor configured to compute a plurality of exposure parameters for the radiation source based on the input data.

2. The system of claim 1, further comprising a control system configured to initialize the radiation source based on the computed plurality of exposure parameters.

3. The system of claim 1, wherein the exposure parameters comprise a current input parameter, an exposure time and a voltage input parameter of the radiation source.

4. The system of claim 1, further comprising a detector configured to receive the radiation passing through the object.

5. The system of claim 1, wherein the processor is further configured to generate a plurality of optimum exposure parameters using an optimization algorithm.

6. The system of claim 5, wherein the optimization algorithm uses a contrast to noise ratio to determine the optimum exposure parameters.

7. The system of claim 5, wherein the optimization algorithm is modeled on a plurality of types of radiation sources and radiation detectors.

8. The system of claim 1, wherein the object comprises at least one of a metallic material and a non-metallic material.

9. The system of claim 1, wherein the input data comprises at least one of a thickness of the object, a type of radiation source, a material of the object, a distance between the radiation source and a radiation detector and a magnification factor.

10. A method for radiographic inspection of an object, the method comprising:
irradiating an object with radiation;
generating a graphical user interface comprising a plurality of fields,
providing input data in at least one of the plurality of fields; and
computing a plurality of exposure parameters based on the input data, wherein the input data comprises at least one of a thickness of the object, a type of radiation source, a material of the object, a distance between a radiation source and a radiation detector and a magnification factor.

11. The method of claim 10, further comprising initializing the radiation source with the plurality of exposure parameters.

12. The method of claim 10, further comprising receiving the radiation passing through the object using a detector.

13. The method of claim 10, the plurality of parameters is generated based on an optimization algorithm.

14. The method of claim 13, wherein the optimization algorithm is modeled on a plurality of types of radiation sources.

15. The method of claim 13, wherein the optimization algorithm is modeled on a plurality of detector responses for a corresponding plurality of types of radiation detectors.

16. The method of claim 15, wherein the plurality of detector responses is computed based on the absorbed radiation energy and a gray scale response of the corresponding radiation detectors.

17. The method of claim 13, wherein the optimization algorithm is modeled on radiation material interaction information for a plurality of materials.

18. The method of claim 17, wherein the radiation material interaction information comprises scatter to direct ratio.

19. The method of claim 13, wherein the optimization algorithm uses an image quality metric to generate the plurality of parameters.

20. The method of claim 19, wherein the image quality metric comprises a contrast-to-noise (CNR) ratio per unit incident radiation dose.
